(19) United States
(12) Patent Application Publication
(10) Pub. No.: US 2014/0317637 A1
(43) Pub. Date: Oct. 23, 2014

(54) Method and System for Conducting Mobile Application to Mobile Application Data Exchange

(71) Applicant: MPayMe Ltd., Hong Kong (HK)

(72) Inventor: Alessandro GADOTTI, Hong Kong (HK)

(21) Appl. No.: 14/321,827

(22) Filed: Jul. 2, 2014

Related U.S. Application Data
(63) Continuation-in-part of application No. 13/602,197, filed on Sep. 2, 2012.
(60) Provisional application No. 61/842,384, filed on Jul. 3, 2013.

(51) Int. Cl. G06F 9/54

(52) U.S. Cl. CPC G06F 9/546
USPC 719/313

(57) ABSTRACT

A method for exchanging data between a first mobile application and a second mobile application running in a mobile communication device, comprising: determining, by the first mobile application, a registered protocol handler of the second mobile application, wherein the registered protocol handler of the second mobile application is recorded in the mobile communication device upon installation of the second mobile application in the mobile communication device; forming, by the first mobile application, a query string of one or more parameter name-value pairs to be appended to the registered protocol handler of the second mobile application; requesting, by the first mobile application, the registered protocol handler of the second mobile application that is appended with the query string; receiving, by the second mobile application, the request by the first mobile application; and extracting, by the second mobile application, the one or more parameter name-value pairs in the query string.

### CLAIM FOR DOMESTIC PRIORITY

This application claims priority under 35 U.S.C. §119 to the U.S. Provisional Patent Application No. 61/842,384, filed Jul. 3, 2013, the disclosure of which is incorporated herein by reference in its entirety.

### CROSS-REFERENCES TO RELATED APPLICATIONS

This application is a continuation-in-part application of the U.S. patent application Ser. No. 13/602,197 filed Sep. 2, 2012, the disclosure of which is incorporated herein by reference in its entirety.

### FIELD OF THE INVENTION

The present invention relates generally to methods and systems of exchanging data between mobile applications running in a mobile communication device.

### BACKGROUND

While the secure mobile payment method and system described in the U.S. patent application Ser. No. 13/602,197 enables the use of mobile communication technology in conducting financial transactions using existing infrastructures, there exist a need for existing mobile payment systems, online shopping systems, and other financial transaction management systems to easily integrate with the secure mobile payment method and system described in the U.S. patent application Ser. No. 13/602,197.

### SUMMARY

It is an objective of the present invention to provide a method and system for third party mobile application to integrate with the secure mobile payment method and system described in the U.S. patent application Ser. No. 13/602,197. It is a further objective of the presently claimed invention to provide such method and system that allows the data exchanges to occur among third party mobile applications, the secure mobile payment mobile application, and the central process server in the secure mobile payment system described in the U.S. patent application Ser. No. 13/602,197.

In accordance with various embodiments, the presently claimed invention comprises a central processing server accessible through a first communication network, such as the Internet; a plurality of users; mobile communication devices and client computing devices that can access the central processing server through the first communication network; and one or more third party computing processors connected to the central processing server through a second communication network, which can be the same as the first communication network.

In accordance with various embodiments, the functionalities of the central processing server comprises user account management for managing user accounts and authenticating users, wherein the user accounts contain user identification and banking information, and are stored securely in a data repository. The banking information includes information on one or more funding sources, such as credit cards, debit cards, and bank accounts; and fund receiving destinations. The central processing server provides the functionality of an electronic repository of credits or monetary units for each user account. The central processing server also provides transaction clearance functionality for processing payments and financial transactions for the users associated with the user accounts. The central processing server provides backend network connections and machine-to-machine integration mechanisms, such as application program interfaces (APIs), to connect and interface with financial institutions, financial exchanges, and clearance centers, facilitating the processing of payments and financial transactions for and between the users associated with the user accounts.

In accordance with various embodiments, the central processing server includes a plurality of user interfaces for user interaction using various types of computing devices and mobile communication devices running web browser applications. In addition, the central processing server also includes secure mobile payment server backend APIs for machine-to-machine integration enabling specially-developed applications running in computing devices or mobile communication devices to communicate with the central processing server. These user interfaces and secure mobile payment server backend APIs facilitate the functionalities including, but are not limited to, user account management and online shopping by users, system administration by administrators, online shopping inventory, payment, and fulfillment management by users.

In accordance with various embodiments, each user account in the secure mobile payment system may associate (pair) with only a single mobile communication device at any one time.

In accordance with various embodiments, the mobile communication device is configured to execute a mobile payment process, and such configuration is accomplished by installing and executing application software and/or firmware specifically designed for the mobile communication device (hereinafter referred to as “secure mobile payment mobile application”) in the mobile communication device. In accordance with various embodiments, the mobile communication device is capable of running multiple mobile applications including the secure mobile payment mobile application and third party mobile applications in parallel. In accordance with various embodiments, the operating system (OS) of the mobile communication device provides a mechanism to facilitate inter mobile application communications and data exchanges. Such mechanism includes, but not limited to, APIs and registered protocol handlers in the form of universal resource locator (URL). Optionally, the OS of the mobile communication device is modified and/or configured to accomplish portions or all of the aforementioned functionalities.

In one aspect of the present invention, a third party mobile application integrates with the secure mobile payment system by exchanging data with the secure mobile payment mobile application running in a mobile communication device using an URL aggregation method. The URL aggregation method comprises the third party mobile application initiating a data exchange with the secure mobile payment mobile application by requesting its registered protocol handler URL with one or more parameters and their corresponding parametric data values under the Hypertext Transfer Protocol (HTTP) GET method. In turn, the secure mobile payment mobile application communicates with the central processing server to facilitate the secure mobile payment process.

In another aspect of the present invention, a third party mobile application integrates with the secure mobile payment system by communicating and exchanging data with the central processing server using an application programming interface (API) calls method, wherein the APIs are provided in a secure mobile payment software development kit (SDK) to be incorporated by the third party mobile application.

### BRIEF DESCRIPTION OF THE DRAWINGS

Embodiments of the invention are described in more detail hereinafter with reference to the drawings, in which

FIG. 1 shows a block diagram illustrating an embodiment of the presently claimed secure mobile payment system; and

FIG. 2 depicts a data flow diagram illustrating an embodiment of a third party mobile application integrated with the secure mobile payment system using the application programming interface (API) calls method.

### DETAILED DESCRIPTION

In the following description, methods and systems of integration, communications, and data exchanges between third party mobile applications and the secure mobile payment system and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

System:

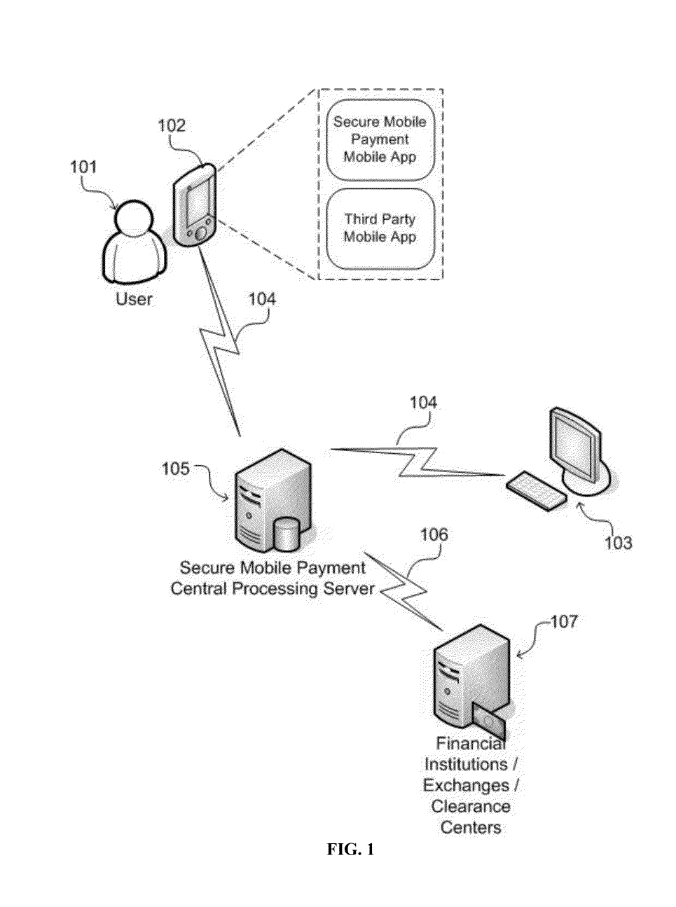

Referring to FIG. 1. In accordance with various embodiments the presently claimed invention comprises a central processing server 105 accessible through a first communication network 104, which can be the Internet, a telecommunication network, or any network supporting the TCP/IP protocol; a plurality of users 101 each associating with a user account; mobile communication devices 102; optionally point of sale (POS) terminals/counters/kiosks 103 that can access the central processing server through the first communication network 104; financial institutions, exchanges and clearance centers 107 connected to the central processing server 105 through a second communication network 106, which can be the same as the first communication network 104 or a separate communication network.

In accordance with various embodiments, the functionalities of the central processing server 105 comprises user account management for managing user accounts and authenticating users, wherein a data record of a user account comprises the user's identification and banking information. The banking information includes information on one or more funding sources, such as credit cards, debit cards, and bank accounts; and fund receiving destinations. The central processing server 105 provides the functionality of an electronic repository of credits or monetary units for each user account. The central processing server 105 also provides transaction clearance functionality for processing payments and financial transactions for the users associated with the user accounts. The central processing server 105 has backend network connections and machine-to-machine integration mechanisms, such as APIs, to connect and interface with the financial institutions, financial exchanges, and clearance centers 107, facilitating the processing of payments and financial transactions for and between the users 101 associated with the user accounts.

In accordance with various embodiments, the central processing server 105 includes at least one group of user interfaces for users accessible by the mobile communication devices 102 through the first communication network 104. The group of user interfaces include interactive transactional web sites that can be displayed in web browser applications running in the mobile communication devices 102 and other computing devices, and user interfaces that are specifically designed for specifically-developed mobile applications running in the mobile communication devices 102. One exemplary embodiment of such user interface is a mobile application (App) running on the iOS® operating system developed by Apple® Inc. Another exemplary embodiment of such user interface is a mobile application (App) running on the Android® operating system developed by Google® Inc. The central processing server also provides another group of user interfaces for system administrative users accessible by the mobile communication devices 102 and other computing devices through the first communication network 104.

In addition to the groups of user interfaces, the central processing server 105 also includes secure mobile payment server backend APIs for machine-to-machine integration, enabling specifically-developed software applications running in mobile communication devices or other computing devices to communicate with the central processing server 105. In accordance to various embodiments, the machine-to-machine data interchanges via the secure mobile payment server backend APIs supports industry standards including, but are limited to, XML and JSON.

These user interfaces and secure mobile payment server backend APIs facilitate the functionalities including, but are not limited to, user account management and online shopping by users, system administration by administrators, online shopping inventory, payment, and fulfillment management by users.

In accordance with various embodiments, the central processing server 105 includes a database for preserving data records of the user accounts, information on the financial institutions, financial exchanges, and clearance centers 107, system configuration data, and other meta data. The database can be implemented in the same physical computer server of the central processing server 105, or in a separate physical computer server. Exemplary embodiments of the database are various commercially available relational database management systems such as Oracle® Database and Microsoft® SQL Server.

In accordance with various embodiments, each user account in the secure mobile payment system may associate (pair) with only a single mobile communication device at any one time. Each of the users 101 may also be required to define a security personal identification number (PIN) for his/her user account according to the system configuration.

In accordance with various embodiments, each of the mobile communication devices 102 is equipped with a camera or scanner for optically capturing images of computer-generated barcodes, such as QR codes. In accordance with various embodiments, the mobile communication device is configured to process the captured barcode image and initiate the mobile payment process. In accordance with various embodiments, the mobile communication device configuration for processing the barcode and executing the mobile payment process is accomplished by installing and executing the secure mobile payment mobile application in the mobile communication device. In accordance with various embodiments, the mobile communication device is capable of running multiple mobile applications including the secure mobile payment mobile application and third party mobile applications in parallel. In accordance with various embodiments, the OS of the mobile communication device provide a mechanism to facilitate inter mobile application communications and data exchanges. Such mechanism includes, but not limited to, APIs and registered protocol handlers in the form of URL. Optionally, the OS of the mobile communication device is modified and/or configured to accomplish portions or all of the aforementioned functionalities.

URL Aggregation:

In accordance to one embodiment, a third party mobile application integrates with the secure mobile payment system by exchanging data with the secure mobile payment mobile application running in a mobile communication device using an URL aggregation method.

In certain OS of mobile communication devices, such as the Apple® iOS®, inter mobile application communications and data exchanges are accomplished by requesting a registered protocol handler of a mobile application. Under this scheme, a protocol handler, for example “abc://” for the mobile application named “abc,” is recorded by the OS when the “abc” mobile application is installed in the mobile communication device. Then, to pass data to the “abc” mobile application, another mobile application requests the URL “abc://<application specific URI>?param1=value1 . . . ” In general, this scheme of inter mobile application communications and data exchanges loosely follows the specification of URL protocol as disclosed in the Network Working Group Request for Comments (RFC) 3986 by The Internet Society; the disclosure of which is incorporated herein by reference in its entirety.

The URL aggregation method comprises the third party mobile application initiating a data exchange with the secure mobile payment mobile application by requesting its registered protocol handler URL with one or more parameters and their corresponding parametric data values under the Hypertext Transfer Protocol (HTTP) GET method. In turn, the secure mobile payment mobile application communicates with the central processing server to facilitate the secure mobile payment process. The registered protocol handler URL of the secure mobile payment mobile application is recorded by the OS when the secure mobile payment mobile application is installed in the mobile communication device.

An exemplary embodiment of the parameter name-value pairs is provided in Table 1 and Table 2 below:

TABLE 1
Parameter Name-value Pairs of the URL Request by the Third Party Mobile
Application Initiating Communication with the Central Processing Server

| Parameter | Parameter Name | Possible Values | Description |
|---|---|---|---|
| Function | f | z—secure | Perform a secure mobile |
| | (optional) | mobile payment | payment system information |
| | | system | query action; parameter q is |
| | | information | required. |
| | | query | |
| QR/Barcode | q (optional; but | | Quick Response (QR) |
| Data String | required if | | code/barcode data string that is |
| | parameter f is | | originally generated by i.e. a |
| | specified) | | merchant's POS for a payment; |
| | | | or for merchandise |
| | | | price labeling. |
| Merchant | i | alphanumeric | If the third party mobile |
| Invoice | (optional) | (20) | application wants to have an |
| Reference | | | invoice as reference, this |
| | | | parameter can be used. If i is |
| | | | specified, it will be validated for |
| | | | uniqueness. |
| Return | r | alphanumeric | The third party mobile |
| URL | (optional) | (25) | application may choose to have |
| | | | a return URL (or registered |
| | | | protocol handler) for the secure |
| | | | mobile payment mobile |
| | | | application to request for |
| | | | passing respond data back to the |
| | | | third party mobile application. |
| | | | The passing back of respond |
| | | | data to the third party mobile |
| | | | application follows the |
| | | | mechanism of Universal Text |
| | | | Linking (UTL) as specified in |
| | | | RFC 3986. |
| Application | n (required if | alphanumeric in | If Return URL is specified, the |
| Name | parameter r is | UTF-8 format (25) | name of the third party mobile |
| | specified) | | application must be specified. |

If the Return URL parameter is specified, the secure mobile payment mobile application returns with responding data to the data exchange initiated by the third party mobile application by requesting the URL specified in the Return URL parameter (parameter r) with the parameter name-value pairs provided in Table 2 below:

TABLE 2
Parameter Name-value Pairs of the URL Request by the Central Processing
Server Responding to the Third Party Mobile Application

| Parameter | Parameter Name | Possible Values | Description |
|---|---|---|---|
| Status | s | s—successful | Transaction was |
| | | | completed successfully. |
| | | f—failed | Transaction failed. |
| | | i—insufficient | Transaction failed due to |
| | | fund | insufficient fund to settle the |
| | | | payment amount demanded. |
| | | e—expired card | Transaction failed due to |
| | | | expired credit card or bank card |
| | | | used for settling the payment |
| | | | amount demanded. |
| Secure | t | alphanumeric | Transaction reference number |
| Mobile | | (32) | used by the secure |
| Payment | | | mobile payment system. |
| System | | | |
| Transaction | | | |
| Reference | | | |
| Merchant | i | alphanumeric | The invoice reference used by |
| Invoice | (optional) | (20) | the third party mobile |
| Reference | | | application and specified in the |
| | | | parameter i in the URL |
| | | | requesting by the third |
| | | | party mobile application. |

An exemplary URL request by the third party mobile application to the central processing server is provided below:

https://znp.bz/z?q=Fwkdn129rQ&i=1234&r=thirdpartyapp%3A%2F%2FexportData& n=3rdpartyshop

An exemplary URL request by the secure mobile payment mobile application responding to the third party mobile application is provided below:

thirdpartyapp://exportData?s=s&t=98z76&i=1234

SDK API Calls:

The HTTP and HTTPS GET method query string in an URL under the URL aggregation method has character length limitation. For better handling of large data exchanges, such as a data transfer of information of a large online shopping checkout transaction, the present invention provides another mechanism.

In accordance to another embodiment, a third party mobile application integrates with the secure mobile payment system by communicating and exchanging data with the central processing server using an application programming interface (API) calls method, wherein the APIs are provided in a secure mobile payment software development kit (SDK) to be incorporated by the third party mobile application.

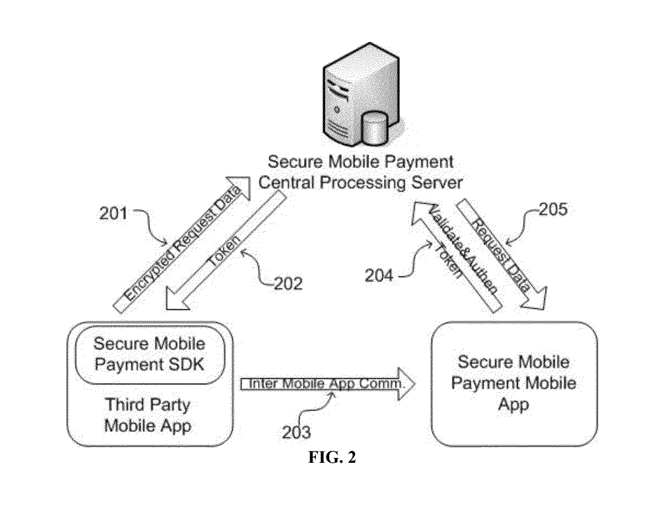

Referring to FIG. 2. The API calls method comprises the following steps:

1. (201) A third party mobile application running in a mobile communication device initiates communication with the secure mobile payment system by invoking an API call provided in the secure mobile payment SDK to the central processing server. The API call accepts from the third party mobile application one or more input parametric data including, but not limited to, those listed in Table 3 below:

TABLE 3
Parameter Name-value Pairs of the API Call by the Third Party Mobile Application
Initiating Communication with the Central Processing Server

| Parameter | Possible Values | Description |
|---|---|---|
| Function | z—secure mobile | Perform a secure mobile payment system |
| | payment system | information query action; the QR/Barcode |
| | information query | Data String parameter is required. |
| | | Direct the user to the secure mobile payment |
| | | system user registration user interface of the |
| | | central processing server. |
| QR/Barcode | | Quick Response (QR) |
| Data String | | code/barcode data string |
| | | that is originally generated |
| | | by i.e. a merchant's |
| | | POS for payment; or for |
| | | merchandise price labeling. |
| Merchant | alphanumeric | If the third party mobile application wants to |
| Invoice | (20) | have an invoice as reference, this parameter |
| Reference | | can be used. If the Merchant Invoice Reference |
| | | parameter is specified, it will be validated for |
| | | uniqueness. |
| Application | alphanumeric in UTF- | Identifier of the |
| Identifier | 8 format (25) | third party application |
| | | invoking the API call. |

Upon the invocation by the third party mobile application and receiving the input parametric data, the API encrypts the received input parametric data and sends the encrypted data to the central process server.
2. The central process server receives and decrypts the encrypted data, validates and records the decrypted data in its database; then generates and preserves a token, which is a string of meta data to uniquely reference the third party mobile application's request and its associated decrypted data.
3. (202) The central process server sends the generated token to the third party mobile application.
4. (203) The third party mobile application receives the token and, by using one of the inter mobile application communication mechanisms provided by the OS of the mobile communication device, passes the token to the secure mobile payment mobile application.
5. (204) The secure mobile payment mobile application receives the token, sends the token to the central process server for validation and authentication by matching the token with the records of third party mobile application's request data.
6. (205) If the token is validated and authenticated, the matched record of third party mobile application's request data is retrieved and sent back to the secure mobile payment mobile application.
7. The secure mobile payment mobile application receives the third party mobile application's request data and processes the data, such as presenting the data in its user interfaces, to further the secure mobile payment process.

The embodiments disclosed herein may be implemented using general purpose or specialized computing devices, mobile communication devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, mobile communication devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Exemplary embodiments of mobile communication devices include, but are not limited to, mobile telephones, mobile telephones with personal computer like capability (commonly referred to as “smartphones”), electronic personal digital assistants (PDAs), portable computers with wired or wireless wide-area-network and/or telecommunication capability such as tablet personal computers and “netbook” personal computers. Examples of mobile communication devices include, but not limited to, the Apple® iPhone®, Google® Nexus™ 10, HTC® One™, Nokia® Lumia™, Samsung® Galaxy™, and Sony® Xperia™.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer processor implemented method for exchanging data between a first mobile application and a second mobile application running in a mobile communication device, comprising:
determining, by the first mobile application, a registered protocol handler universal resource locator (URL) of the second mobile application, wherein the registered protocol handler URL of the second mobile application is recorded in the mobile communication device upon installation of the second mobile application in the mobile communication device;
forming, by the first mobile application, a first query string of one or more parameter name-value pairs to be appended to the registered protocol handler URL of the second mobile application;
requesting, by the first mobile application, the registered protocol handler URL of the second mobile application that is appended with the first query string of the one or more parameter name-value pairs;
receiving, by the second mobile application, the request by the first mobile application; and
extracting, by the second mobile application, the one or more parameter name-value pairs in the first query string;
wherein the mobile communication device comprises a computer processor configured to execute instructions of an operating system and mobile applications.

2. The method of claim 1, wherein the one or more parameter name-value pairs comprising a registered protocol handler URL of the first mobile application.

3. The method of claim 2, further comprising:
responding, by the second mobile application, to the first mobile application by requesting the registered protocol handler URL of the first mobile application.

4. A computer processor implemented method for exchanging data between a first mobile application and a second mobile application running in a mobile communication device, comprising:
sending, by the first mobile application, to a central processing server one or more input parametric data;
receiving and storing, by the central processing server, the one more input parametric data;
generating, by the central processing server, a token referencing the one more input parametric data;
sending, by the central processing server, to the first mobile application the token;
receiving, by the first mobile application, the token;
sending, by the first mobile application, the token to second mobile application through an inter mobile application communication means;
receiving, by the second mobile application, the token;
sending, by the second mobile application, the token to the central processing server;
receiving, by the central processing server, the token;
matching and retrieving, by the central processing server, the token to the stored one more input parametric data; and
sending, by the central processing server, to the second mobile application, the stored one more input parametric data.

5. A system for exchanging data between a first mobile application and a second mobile application running in a mobile communication device, comprising:
the first mobile application for executing a first process comprising:
determining a registered protocol handler universal resource locator (URL) of the second mobile application, wherein the registered protocol handler URL of the second mobile application is recorded in the mobile communication device upon installation of the second mobile application in the mobile communication device;
forming a first query string of one or more parameter name-value pairs to be appended to the registered protocol handler URL of the second mobile application; and
requesting the registered protocol handler URL of the second mobile application that is appended with the first query string of the one or more parameter name-value pairs; and
the second mobile application for executing a second process comprising:
receiving the request by the first mobile application; and
extracting the one or more parameter name-value pairs in the first query string;
wherein the mobile communication device comprises a computer processor configured to execute instructions of an operating system and mobile applications.

6. The system of claim 5, wherein the one or more parameter name-value pairs comprising a registered protocol handler URL of the first mobile application.

7. The system of claim 6, wherein the second process further comprising:
responding to the first mobile application by requesting the registered protocol handler URL of the first mobile application.
